(19) United States
(12) Patent Application Publication
(10) Pub. No.: US 2026/0145936 A1
(43) Pub. Date: May 28, 2026

(54) INTEGRATION OF CARBON MONOXIDE PREFERRENTIAL OXIDATION WITH A BLUE HYDROGEN PLANT

(71) Applicants: Kihyung Kim, Tonawanda, NY (US); Troy M. Raybold, Tonawanda, NY (US); Chirag Mevawala, Tonawanda, NY (US); Luke J. Coleman, The Woodlands, TX (US)

(72) Inventors: Kihyung Kim, Tonawanda, NY (US); Troy M. Raybold, Tonawanda, NY (US); Chirag Mevawala, Tonawanda, NY (US); Luke J. Coleman, The Woodlands, TX (US)

(21) Appl. No.: 18/961,905

(22) Filed: Nov. 27, 2024

(51) Int. Cl. C01B 3/58; B01D 53/00; B01D 53/047; B01D 53/14; C01B 3/48; C01B 32/50

(52) U.S. Cl. CPC C01B 3/583; B01D 53/002; B01D 53/047; B01D 53/1475; C01B 3/48; C01B 32/50; B01D 2252/204; B01D 2256/16; B01D 2257/502; B01D 2257/504; B01D 2257/7025; B01D 2257/80; C01B 2203/0205; C01B 2203/0283; C01B 2203/042; C01B 2203/044; C01B 2203/047; C01B 2203/0475; C01B 2203/048; C01B 2203/0495; C01B 2203/0883; C01B 2203/1241; C01B 2203/148; C01P 2006/80

(57) ABSTRACT

The present invention relates to utilization of a carbon monoxide (CO) preferential oxidation reactor (PrOx) in blue hydrogen plants to maximize hydrogen (H₂) production and carbon dioxide (CO₂) capture.

### BACKGROUND OF THE INVENTION

### Field of the Invention

The present invention relates to utilization of a carbon monoxide (CO) preferential oxidation reactor (PrOx) in blue hydrogen plants to maximize carbon dioxide (CO₂) capture. Through this invention, the CO PrOx is integrated into the blue hydrogen plant to reduce CO by converting the CO into CO₂ which is subsequently captured and sequestered.

### Description of Related Art

Hydrogen has been produced at various scales using fossil feedstocks to achieve the lowest production cost. The choice of feedstock will be dependent on the access to feedstock, security of supply, price, and geography; but natural gas is the most common feedstock to produce hydrogen today. With the recent attention to greenhouse gas (GHG) emissions, both academics and industrial sectors have been focusing on new technologies to reduce the carbon footprint of hydrogen production processes.

Hydrocarbons such as natural gas, naphtha, or liquefied petroleum gas (LPG) can be converted with steam and optionally O₂ to obtain a synthesis gas (i.e., a mixture of H₂ and CO, commonly referred to as “syngas”) through several known processes such as steam methane reforming (SMR), autothermal reforming (ATR) or partial oxidation (POx). Deployment of carbon capture and storage (CCS) technology is one way to reduce GHG, primarily CO₂ emissions, from these conventional fossil feedstock hydrogen production processes. H₂ production in this manner is commonly referred to as “blue H₂”.

There are multiple technology and process flowsheet options available to capture carbon dioxide in the hydrogen production process that have been described extensively in the open literature. Captured carbon is, in essence, permanently stored in suitable geological formations or sequestered. The degree of carbon removal or carbon capture rate (CCR) can be in the range from 50% to 99%. One of these technical options is Linde's own HISORP® adsorption-based carbon capture such as the one shown in International Publication Nos. WO 2023/030693 A1 and WO 2023/117130 A1 which are incorporated herein by reference.

Typically, blue H₂ plants are equipped with one or more water-gas-shift reactors (e.g., high temperature shift, medium temperature shift, low temperature shift) in order to maximize H₂ production and CO₂ capture. These plants generally target 0.5 to 1 mole percent on a dry basis of CO slip in the syngas that exits the last water-gas-shift reactor. Therefore, this provides an opportunity to capture an additional 2 to 4 percent of CO₂ through the use of carbon monoxide preferential oxidation reactors (CO PrOx). These CO PrOx's are known as industrial devices designed to eliminate CO in H₂ rich streams and have been commonly used in fuel cell applications which has a similar gas composition to the syngas of blue H₂ plant at the last stage of water-gas-shift reactor (about 60-200 of H₂/CO ratio). Certain applications of CO PrOx have been proposed in the related art. For instance, World International Application 2023/144869; U.S. Pat. Nos. 10,345,304 B2, 11,286,168 B2 and 8,445,402 B2 assigned to Johnson Matthey propose the use of a PrOx unit in an ATR-based blue H₂ plant, but not in the current context. However, CO PrOx units have not been employed in said H₂ plants in the manner described in the method of the present invention to convert CO to CO₂ from a syngas stream and convert and capture an additional 2 to 4 percent of CO₂. It is an object of the invention to provide a blue hydrogen plant having a configuration where the tail gas from the hydrogen pressure swing adsorption (H₂ PSA) unit is routed to the CO PrOx unit to convert slip stream of CO into CO₂ and routing the latter to the carbon capture unit. This provides several benefits including:
No impacts on H₂ production;
Less catalyst volume in the CO PrOx;
Low operating cost by lower pressure;
Ability to utilize existing cooling system for thermal management; and
Less concern of water condensation.

Other objects and aspects of the present invention will become apparent to one of ordinary skilled in the art upon review of the specification, drawings and claims appended hereto.

### SUMMARY OF THE INVENTION

According to an aspect of the invention, a method producing a blue hydrogen including:
i. reforming a hydrocarbon gas mixture stream with steam and optionally an oxygen-rich gas in a reformer to produce a syngas stream,
ii. recovering thermal energy of the syngas stream in a process heat recovery unit downstream of the reformer, thereby cooling the syngas stream,
iii. converting carbon-monoxide of a cooled syngas to carbon-dioxide and hydrogen by subjecting it to one or more water-gas-shift-units to provide a hydrogen-enriched shifted syngas,
iv. recovering thermal energy of the hydrogen-enriched shifted syngas thereby cooling the hydrogen-enriched shifted syngas and separating condensed water therefrom,
v. separating the hydrogen-enriched shifted syngas by subjecting it to a hydrogen pressure swing adsorption (H₂ PSA) process thereby forming a hydrogen product stream and a lower-pressure tail gas stream,
vi. introducing at least a portion of the lower-pressure tail gas stream and an oxygen-containing gas to a CO preferential oxidation catalyst unit to provide a carbon-dioxide-enriched tail gas stream therefrom, and
vii. passing the carbon-dioxide-enriched tail gas stream to a carbon-dioxide separation unit to provide a carbon-dioxide product stream and a carbon-dioxide depleted gas stream, wherein the carbon-dioxide product stream is sent to a sequestration process and at least a portion of the carbon-dioxide depleted gas stream is recycled to the process as a feedstock and/or a fuel.

### BRIEF DESCRIPTION OF THE FIGURES

The objects and advantages of the invention will be better understood from the following detailed description of the preferred embodiments thereof in connection with the accompanying figure wherein like numbers denote same features throughout and wherein:

FIG. 1 is a process flow diagram illustrating a blue hydrogen plant with CO preferential oxidation reactor for H₂ PSA tail gas configuration; and

FIG. 2 is a process flow diagram illustrating CO PrOx integration embodiments with HISORP® carbon capture.

### DETAILED DESCRIPTION OF THE INVENTION

The present invention provides a novel blue hydrogen process which utilizes a CO PrOx unit to convert CO into CO₂ and route a greater amount of the carbon to a carbon capture unit, such as Linde's own HISORP®.

A CO PrOx reactor/unit is an industrial device designed to reduce carbon monoxide (CO) from hydrogen-rich gas streams. The process involves preferentially oxidizing CO in the presence of excess hydrogen. The reactor uses a catalyst typically made up of precious metals such as platinum or palladium, supported on materials such as alumina or ceria. The catalyst helps increase the reaction rate by providing a surface to facilitate the chemical reaction. The reaction usually takes place at a relatively low temperature of around 40° C. to 200° C. and under a pressure range of 1 to 20 bara. The chemical reaction of CO preferential oxidation converts CO to carbon dioxide CO₂ through the following chemical equation:

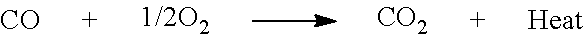

This reaction is exothermic, and the heat produced is used to maintain the reaction temperature. Overall, the carbon monoxide preferential oxidation reactor is an essential technology that helps clean up industrial processes by reducing pollution.

CO PrOx is beneficial for CO conversion to CO₂, but it cannot avoid some H₂ oxidation and reverse water-gas-shift reaction under certain temperature range. Therefore, CO selectivity and operating temperature are critical to determine CO PrOx performance and flowsheet integration.

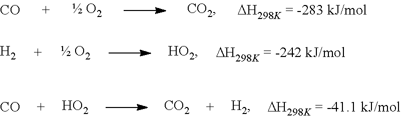

CO PrOx typical operating temperature is over 40° C. up to 200° C. There are a few characteristics of CO PrOx related to operating temperature as:
Once the temperature exceeds 220° C., reverse water-gas-shift reaction may take place;
Complete CO conversion achievable when the operating temperature exceeds ˜160° C.;
O₂ slip may take place below 100° C. at high space velocity (e.g., >20,000/hour);
The lower operating temperature, the higher the CO selectivity.

CO selectivities reported in the literature are typically 50˜ 80% range which means 20˜50% of oxygen reacts with H₂. Thus, depending on the reactor location, it can deleteriously affect (i.e., reduce) H₂ production.

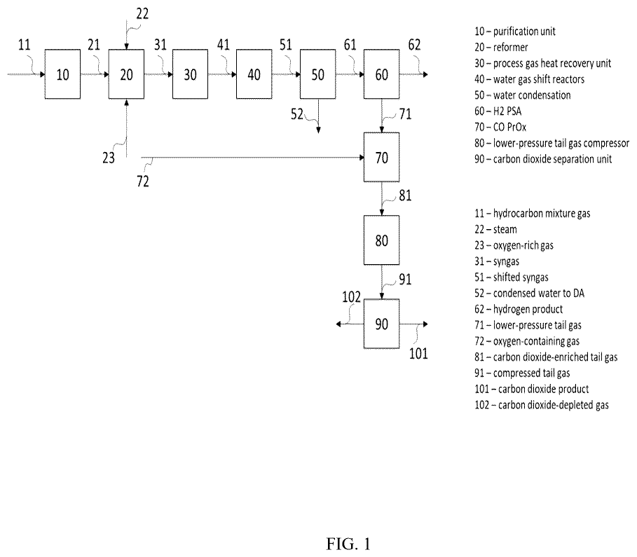

The CO PrOx unit can be integrated downstream of the last stage of the shift reactor. However, considering all the concerns addressed above, the invention determined that the preferred embodiment of CO PrOx would be integrated downstream of H₂ PSA unit processing tail gas. Thus, the present invention provides a method for producing high-quality hydrogen with reduced carbon emissions (i.e., blue hydrogen). With reference to FIG. 1, the process involves multiple steps that reduce carbon emissions while generating hydrogen.

The method commences by providing a hydrocarbon mixture stream gas (11) to a reformer such as a steam methane reformer (SMR), auto thermal reformer (ATR) and/or partial oxidation unit (POx) (20). The reforming of hydrocarbon mixture gas stream (11) can be with steam (22) and optionally an oxygen-rich gas (23) to produce syngas stream (31). The thermal energy of the syngas stream (31) is recovered by a steam generator or process gas heat recovery unit (30) and used for cooling the syngas. The cooled syngas stream (41) is then subjected to one or more water-gas-shift units (40) that convert carbon monoxide to carbon dioxide and hydrogen to obtain hydrogen-enriched shifted syngas (51). The shifted syngas stream (51) is then cooled, and condensed water (52) is separated by recovering its thermal energy in water condensation unit (50). Thereafter syngas stream (61) is provided to an H₂ pressure swing adsorption (PSA) unit (60) which separates hydrogen to form a hydrogen product stream (62) and a lower-pressure tail gas stream (71) inclusive of methane, carbon dioxide, and trace amounts of water and carbon monoxide. The tail gas stream (71) and an oxygen-containing gas (72) are then introduced to a CO PrOx unit (70) to provide a carbon dioxide-enriched tail gas stream (81). The carbon dioxide-enriched tail gas stream (81) is further routed to a tail gas compressor unit (80) which has one or more stages. The compressed carbon dioxide-enriched tail gas stream (91) is fed into a carbon dioxide separation unit (90) to provide a carbon dioxide product stream (101) and a carbon dioxide-depleted gas stream (102). In this preferred embodiment, the hydrocarbon mixture gas stream, preferably natural gas, undergoes desulfurization in unit (10) disposed upstream of the reformer (20). If an ATR or a POx (20) is selected for syngas generation, an air separation unit (not shown) supplies oxygen-rich gas, which preferably contains at least 90% or more preferably, at least 98% vol O₂. The oxygen-containing gas (72) can be a portion of the oxygen-rich gas (23). The oxygen-containing gas can also be a separate stream, such as air or oxygen-enriched air.

A combination of high-temperature shift and low-temperature shift reactors can also be used for the water-gas-shift units (40). The H₂ PSA purifies the hydrogen product to at least 95% vol H₂ and typically >99.99% vol H₂. The CO₂ separation method used may be any type, but preferably it is a cryogenic and adsorption-based separation. The oxidation catalyst used is a CO preferential oxidation catalyst that is made of a noble metal, such as Pd, Pt, Rh, and Ru, supported on a ceramic support, such as alumina.

The invention provides an efficient and sustainable way for the production of blue hydrogen, which can contribute to reducing carbon emissions. The process also enables the separation of carbon dioxide, which can be sent for a sequestration process while recycling the carbon dioxide-depleted gas stream as feedstock and/or fuel. Overall, the present invention provides a cleaner and more efficient way to produce hydrogen, making it a vital breakthrough for the energy transition and climate change. It provides an efficient and environmentally friendly method to produce hydrogen while simultaneously reducing carbon emissions.

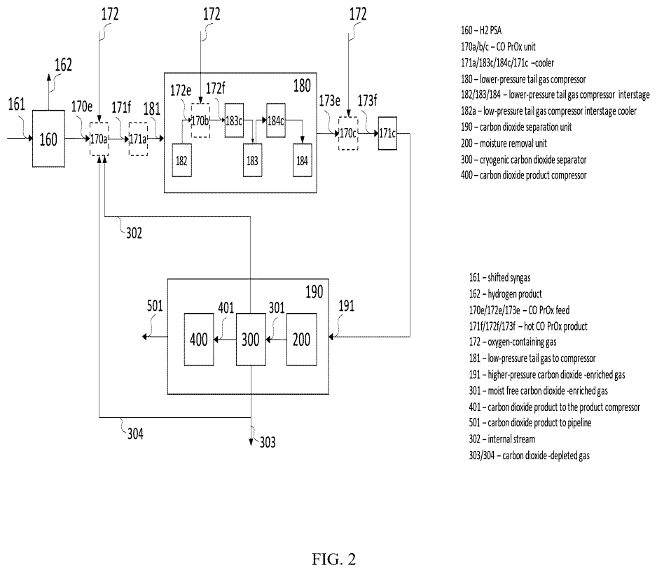

In another embodiment of the invention, and with reference to FIG. 2, the CO PrOx can be disposed of in several locations along with a cryogenic and adsorption-based carbon dioxide separation unit (190). For instance, a shifted syngas stream (161) is provided to an H₂ PSA unit (160) which separates hydrogen to form a hydrogen product stream (162) and a lower-pressure tail gas stream (170e). The tail gas stream (170e) and an oxygen-containing gas (172) are then introduced to a CO PrOx unit (170a).

CO PrOx can be integrated at various locations on the downstream of the tail gas. For example, CO PrOx unit can be placed before the tail-gas compressor unit (180), between inter-stages of the compressor train (180) such as 170a if the compressor has more than one stages such as 170b, or after the tail-gas compressor (180) such as 170c. Carbon dioxide enriched tail-gas (e.g., 171f, 172f, 173f) may add around 100° C. to 200° C. to the CO PrOx feed gas (e.g., 170e, 172e, 173e) via CO PrOx unit due to exothermic oxidation reactions. It may be necessary to remove the additional heat before directing the carbon dioxide enriched tail gas to downstream units like carbon dioxide separation unit (190). Therefore, CO PrOx needs a cooling unit (e.g., 171a, 183c, 171c) to meet a temperature requirement of the downstream unit.

Oxygen-containing gas compression energy can be minimized by selecting the location on the low-pressure tail gas stream (170a). If CO PrOx is placed within the tail-gas compressor unit, it can avoid an additional cooler for CO PrOx and utilize an existing interstage cooler (183c). Another alternate location would be the downstream of the compressed tail-gas (191) before the carbon dioxide separation unit (190), shown as unit (170a) in FIG. 2. The carbon dioxide separation unit may consist of a moisture removal unit (200) to make moisture-free tail gas (301), a cryogenic separator (300) to produce a carbon dioxide product stream (401) and a carbon dioxide-depleted gas stream (303), a CO₂ product stream compressor (400) to pressurize carbon dioxide product to CO₂ pipeline (501), and optionally some other types of gas separators like CO₂ PSA and/or membrane unit to recycle CO/CO₂/H₂/CH₄ molecules in the process. The carbon dioxide depleted gas stream (303) is recycled to the process as a feedstock and/or a fuel, and a portion of the stream (304) can be fed to the CO PrOx unit (170a, or 170b, or 170c) to convert carbon monoxide further more to carbon dioxide. The cryogenic separator (300) may have at least one or more internal recycle streams (302) which can be also fed to the CO PrOx unit (170a, or 170b, or 170c).

The invention is further explained through the following example, which compare the base case of an ATR containing hydrogen plant where there is no CO PrOx, and an example case of the invention with the CO PrOx, which is not to be construed as limiting the present invention.

### Example

This example illustrates strategic positioning of CO PrOx in the blue hydrogen plant by comparing with the base case which has no CO PrOx unit. In this example, the CO PrOx is placed within the tail gas compressor depicted in FIGS. 2 (170b), and 50% of CO selectivity is assumed to convert 50% of CO molecules to CO₂ through the reactor as a conservative baseline. The following tables describe exemplary inlet and outlet gas compositions at dry basis and its impacts on the blue hydrogen plant performance. Since the CO PrOx is placed on a tail gas stream of H₂ PSA, there is no impact on the hydrogen production via the H₂ PSA but it affects CO and H₂ molecules in the H₂ PSA tail gas stream which may 5 be recycled to the process as a feedstock and/or a fuel. Therefore, it alters natural gas feedstock to compensate their heating duties. In overall, CO PrOx is beneficial for both carbon capture and carbon intensity reduction.

| Stream # | 161 | 162 | 181 | 172e | 172 | 172f | 191 | 301 | 401 | 501 |
|---|---|---|---|---|---|---|---|---|---|---|
| Temperature, F. | 101 | 110 | 96 | 210 | 100 | 521 | 93 | 100 | 87 | 101 |
| Pressure, bara | 36.4 | 35.8 | 1.1 | 7.6 | 7.6 | 7.3 | 27.4 | 26.9 | 6.5 | 152 |
| Flow, MMSCFD | 473 | 308 | 192 | 196 | 3 | 196 | 194 | 193 | 123 | 123 |
| Composition, mol % | | | | | | | | | | |
| H₂ | 71.8 | 100.0 | 17.2 | 17.1 | 0.0 | 16.1 | 16.3 | 16.3 | 0.0 | 0.0 |
| N₂ | 0.9 | 0.0 | 2.7 | 2.8 | 0.0 | 2.8 | 2.8 | 2.8 | 0.1 | 0.1 |
| O₂ | 0.0 | 0.0 | 0.0 | 0.0 | 100.0 | 0.0 | 0.0 | 0.0 | 0.0 | 0.0 |
| CO | 1.1 | 0.0 | 3.0 | 3.1 | 0.0 | 1.5 | 1.6 | 1.6 | 0.1 | 0.1 |
| CO₂ | 25.1 | 0.0 | 73.4 | 73.2 | 0.0 | 74.7 | 75.7 | 75.9 | 99.2 | 99.2 |
| H₂O | 0.2 | 0.0 | 0.4 | 0.4 | 0.0 | 1.5 | 0.3 | 0.0 | 0.0 | 0.0 |
| CH₄ | 0.9 | 0.0 | 3.0 | 3.2 | 0.0 | 3.2 | 3.2 | 3.2 | 0.5 | 0.5 |

| | |
|---|---|
| Change of hydrogen production | 0.00% |
| Change of natural gas feedstock | 1.50% |
| Change of carbon dioxide capture rate | 2.60% |
| Carbon intensity reduction (kgCO₂ₑ/kgH₂) | 0.20 |

While the invention has been described in detail with reference to specific embodiments thereof, it will become apparent to one skilled in the art that various changes and modifications can be made, and equivalents employed, without departing from the scope of the appended claims.

What is claimed is:

1. A method for producing hydrogen, comprising:
i. reforming a hydrocarbon gas mixture stream with steam and optionally an oxygen-rich gas in a reformer to produce a syngas stream,
ii. recovering thermal energy of the syngas stream in a process heat recovery unit downstream of the reformer, thereby cooling the syngas stream,
iii. converting carbon-monoxide of a cooled syngas to carbon-dioxide and hydrogen by subjecting it to one or more water-gas-shift-units to provide a hydrogen-enriched shifted syngas,
iv. recovering thermal energy of the hydrogen-enriched shifted syngas thereby cooling the hydrogen-enriched shifted syngas and separating condensed water therefrom,
v. separating the hydrogen-enriched shifted syngas by subjecting it to a hydrogen pressure swing adsorption (H₂ PSA) process thereby forming a hydrogen product stream and a lower-pressure tail gas stream,
vi. introducing at least a portion of the lower-pressure tail gas stream and an oxygen-containing gas to a CO preferential oxidation catalyst unit to provide a carbon-dioxide-enriched tail gas stream therefrom, and
vii. passing the carbon-dioxide-enriched tail gas stream to a carbon-dioxide separation unit to provide a carbon-dioxide product stream and a carbon-dioxide depleted gas stream, wherein the carbon-dioxide product stream is sent to a sequestration process and at least a portion of the carbon-dioxide depleted gas stream is recycled to the process as a feedstock and/or a fuel.

2. The method of claim 1, wherein the hydrocarbon mixture gas stream is selected from the group consisting of natural gas, butane, propane, ethane, and a mixture thereof including impurities.

3. The method of claim 2, wherein the hydrocarbon mixture gas is desulphurized.

4. The method of claim 1, wherein the reformer is a steam methane reformer, an autothermal reformer, or a partial oxidation unit for producing the syngas stream.

5. The method of claim 1, wherein the oxygen-rich gas comprises at least 90% vol O₂, and more preferably at least 98% vol O₂.

6. The method of claim 1, wherein a single or multiple water-gas-shift reactors are arranged in series, more preferably a combination of high-temperature shift reactor and low-temperature shift reactor.

7. The method of claim 1, wherein the H₂ PSA purifies hydrogen product to at least 95% vol H₂, and more preferably >99% vol H₂.

8. The method of claim 1, wherein the CO preferential oxidation catalyst unit consists of one or more catalytic reactors in series.

9. The method of claim 8, wherein the CO preferential oxidation catalyst unit is coupled with at least one cooling unit before, between, within, and/or after the catalytic reactors.

10. The method of claim 1, wherein the oxygen-containing gas is air, oxygen-enriched air, or purified oxygen stream such as greater than 90% vol O₂, and more preferably at least 98% vol O₂.

11. The method of claim 5 or claim 10, wherein the oxygen-containing gas and/or the oxygen-rich gas are derived from an air separation unit, pipeline, or electrolyzer.

12. The method of claim 8, wherein the CO preferential oxidation catalyst consists of a noble metal selected from the group consisting of Pd, Pd, Rh and Ru, supported on a ceramic support such as alumina.

13. The method of claim 8, wherein the CO preferential oxidation reactor consists of one or more layers of CO preferential oxidation catalysts.

14. The method of claim 1, wherein the CO₂ separation unit comprises at least an amine-base CO₂ separation unit.

15. The method of claim 1, wherein the CO₂ separation unit comprises at least a cryogenic and adsorption-based CO₂ separation unit.

16. The method of claim 15, wherein the cryogenic and adsorption-based CO₂ separation unit consists of a lower-pressure tail gas compressor with one or more stages, a moisture removal unit, a cryogenic separator, and a CO₂ product stream compressor.

17. The method of claim 16, wherein the cryogenic and adsorption-based CO₂ separation unit additionally comprises various temperature-swing and/or pressure-swing adsorption units.

18. The method of claim 1, wherein at least the lower-pressure tail gas stream is first partially compressed in one or more compressor stages prior to being introduced to the preferential oxidation catalyst unit.

19. The method of claim 16, wherein at least a portion of the carbon-dioxide depleted gas stream is combined with the lower-pressure tail gas stream in one or more compressor stages.

20. The method of claim 1, wherein a portion of the carbon-dioxide depleted gas stream is fed to the CO preferential oxidation catalyst unit.

21. The method of claim 1, wherein a portion of one or more internal stream from the CO₂ separation unit are fed to the CO preferential oxidation catalyst unit.
